(19) United States
(12) Patent Application Publication
(10) Pub. No.: US 2012/0051613 A1
(43) Pub. Date: Mar. 1, 2012

(54) MAMMOGRAPHY DISPLAYING METHOD AND SYSTEM

(75) Inventors: Takeshi KAMIYA, Kanagawa (JP); Wataru ITO, Kanagawa (JP); Masahiko YAMADA, Kanagawa (JP); Takao KUWABARA, Kanagawa (JP); Tetsuro KUSUNOKI, Kanagawa (JP); Yasunori OHTA, Kanagawa (JP)

(73) Assignee: FUJIFILM CORPORATION, Tokyo (JP)

(21) Appl. No.: 13/220,243

(22) Filed: Aug. 29, 2011

(30) Foreign Application Priority Data
Aug. 30, 2010 (JP) 2010-192197

(51) Int. Cl. G06K 9/00

(52) U.S. Cl. 382/128

(57) ABSTRACT

Stereoscopic images of a pair of left and right breasts are displayed in a comparatively readable manner by matching the sense of depths of each stereoscopic image. In a mammography displaying system that captures a plurality of images having parallax for each of a pair of left and right breasts while a pair of the left and right breasts are compressed, respectively and displays a stereoscopic image having a plurality of images regarding one of the breasts and a stereoscopic image having a plurality of images regarding the other breast on display unit in a comparatively readable manner, there are provided compressed thickness detection unit 34 for detecting compressed thicknesses for each of the breasts when images are captured; and imaging control unit 2a and 31 for capturing a plurality of images by enlarging parallax as the detected compressed thickness is small.

### BACKGROUND OF THE INVENTION

1. Field of the Invention

The present invention relates to a mammography displaying method and a mammography displaying system for performing the same, and more particularly, to a mammography displaying method and system capable of displaying a pair of mammographic images in a comparatively readable manner as stereoscopic images.

2. Description of the Related Art

In the related art, a 3-dimensional view technique using parallax by displaying a plurality of images in combination is known. Such a 3-dimensional view image (hereinafter, referred to as a stereoscopic image or a stereo image) is generated based on a plurality of images having different parallax obtained by imaging the same subject from different positions.

Moreover, such way of generating stereoscopic image is utilized not only in the field of digital cameras and televisions but also in the field of capturing a stereoscopic radiological image. That is, a test subject is irradiated with radiation from different directions, the radiation passing through the test subject is detected by a radiological image detector to acquire plural radiological images having parallax, and a stereoscopic image is generated based on the radiological images. By generating a stereoscopic image in this way, a radiological image with a sense of depth can be observed and thereby more suitable radiological image for diagnosis can be observed.

Imaging and displaying the aforementioned radiographic images is widely applied to capturing/displaying mammographic images as disclosed in JP2010-110571A. In the mammographic image capturing/displaying, typically, the radiographic image is captured while the breast is compressed and flattened by a compression plate.

Meanwhile, for example, as disclosed in JP2001-204721A, 2-dimensional radiographic images for left and right breasts can be displayed in a comparatively readable manner. More specifically, according to JP2001-204721A, radiographic images for each of a pair of left and right breasts are arranged to face back to back and displayed on display unit.

### SUMMARY OF THE INVENTION

In imaging and displaying the breast images described above, it is envisaged that a plurality of right breast stereoscopic images and a plurality of left breast stereoscopic images are displayed on display unit in a comparatively readable manner. In this case, two sets of stereoscopic images are displayed side by side on the same display screen. In addition, it may be envisaged that they may be displayed on different display screens (that is, the screens may be displayed on single display unit with a time interval, or they may be displayed using display screens of different display unit).

However, in the mammography displaying system of the related art, as described above, when the stereoscopic images on a pair of left and right breasts are displayed in a comparatively readable manner, a sense of depth may be different in stereoscopic images of each breast. If such a condition is continued, it is difficult to achieve the comparative reading, and problems such as erroneous diagnosis are likely to result. Particularly, in a case where a plurality of stereoscopic images are displayed on the same display screen, there is a disadvantage in that it is difficult to achieve a stereoscopic view, and the eyes of the reader may be easily fatigued.

The present invention has been made in view of the above-mentioned problems and an object of the present invention is to provide a mammography displaying method capable of displaying stereoscopic images for a pair of left and right breasts in a comparatively readable manner by matching sense of depths therebetween.

In addition, the present invention provides a mammography displaying system capable of performing such a mammography displaying method.

According to an aspect of the present invention, there is provided a mammography displaying method using a mammography displaying system that captures a plurality of images having parallax for each of a pair of left and right breasts while a pair of the left and right breasts are compressed respectively, and displays a stereoscopic image having a plurality of images regarding one of the breasts and a stereoscopic image having a plurality of images regarding the other breast on display unit in a comparatively readable manner, the method including detecting compressed thicknesses for each of the breasts when images are captured; and capturing a plurality of images by enlarging parallax as the detected compressed thickness is small.

According to another aspect of the present invention, there is provided a mammography displaying system that captures a plurality of images having parallax for each of a pair of left and right breasts while a pair of the left and right breasts are compressed respectively, and displays a stereoscopic image having a plurality of images regarding one of the breasts and a stereoscopic image having a plurality of images regarding the other breast on display unit in a comparatively readable manner, including compressed thickness detection unit for detecting compressed thicknesses for each of the breasts when images are captured; and imaging control unit for capturing a plurality of images by enlarging parallax as the detected compressed thickness is small.

Preferably, the compressed thickness detection unit may detect the compressed thickness based on a position of the compression plate that compresses the breast when images are captured.

Preferably, the imaging control unit may control parallax by controlling the imaging angle (an angle of the irradiation axis with respect to the radiation detection surface) when a plurality of images are captured.

The inventors acknowledges that a problem of the related art, in that sense of depths of each stereoscopic image regarding left and right breasts are differently displayed, is caused by a fact that images are captured while thicknesses of each breast are different from each other. That is, left and right breasts are typically captured individually, the compressing degree caused by the compression plate during each imaging may be different, and the sizes of the left and right breasts may be different. Therefore, in many instances, images of left and right breasts are captured while they have different compressed thicknesses.

In consideration of such knowledge, in the mammography displaying method of the present invention, compressed thicknesses of each breast are detected when images are captured, and a plurality of images are captured by increasing parallax as the detected compressed thickness is small. Originally the sense of depth of the stereoscopic image is low as the compressed thickness of the breast is small during images are captured. In this case, it is possible to improve the sense of depth of the stereoscopic image displayed from a plurality of images by capturing a plurality of images with enlarging parallax. At this point, stereoscopic images regarding a pair of left and right breasts can be displayed with the matched sense of depth.

In the mammography displaying system according to the present invention, since there are provided compressed thickness detection unit for detecting compressed thicknesses for each of the breasts when images are captured; and imaging control unit for capturing a plurality of images by enlarging parallax as the detected compressed thickness is small, it is possible to embody the mammography displaying method of the present invention described above.

### BRIEF DESCRIPTION OF THE DRAWINGS

FIG. 1 is a schematic diagram illustrating a medical image information system having a mammography displaying system according to an embodiment of the present invention.

FIG. 2 is a side view illustrating a mammographic imaging unit used in the mammography displaying system of FIG. 1.

FIG. 3 is a front view illustrating the mammographic imaging unit of FIG. 2.

FIG. 4 is a block diagram illustrating a part of the mammographic imaging unit and a configuration for controlling the mammographic imaging unit.

FIG. 5 is a schematic diagram illustrating an exemplary display state of left and right mammographic images.

FIGS. 6A and 6B are schematic diagrams illustrating an exemplary imaging state of the mammography displaying system according to an embodiment of the present invention.

FIG. 7 is a schematic diagram illustrating another exemplary display state of left and right mammographic images.

### DESCRIPTION OF THE PREFERRED EMBODIMENTS

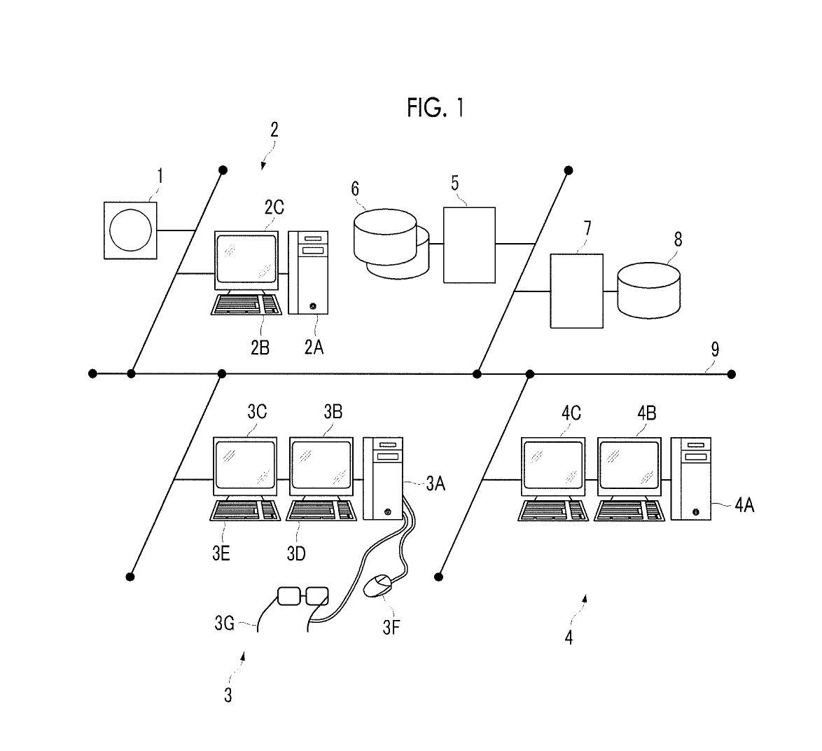

Hereinafter, embodiments of the present invention will be described in detail with reference to the accompanying drawings. FIG. 1 illustrates a schematic configuration of a medical image information system having a mammography displaying system according to an embodiment of the present invention. Using the medical image information system, images of the examination target area of the examinee are captured and stored based on an examination order from a diagnostician, the captured images are read by a radiologist to generate an image interpretation report, and the diagnostician reads the image interpretation report and inspects the radiographic images.

As illustrated, the medical image information system includes an imaging unit 1 that captures mammographic images, a computer system 2 for controlling capturing of the radiographic images in the mammographic imaging unit 1, a radiologist workstation 3, a diagnostician workstation 4, an image information management server 5, an image information database 6, an image interpretation report server 7, and an image interpretation report database 8 communicatably connected via networks 9. Each of the units or devices is controlled by a program installed from a recording medium such as a CD-ROM.

The radiologist workstation 3 is a computer used to read images or generate an image interpretation report by a radiologist, and is installed with hardware components such as a CPU, a main storage unit, a subsidiary storage unit, an input/output interface, a communication interface, an input device, and a data bus, as well as software components such as an operating system well-known in the art. More specifically, the radiologist workstation 3 includes a computer main unit 3A, two displays (display unit) 3B and 3C, keyboards 3D and 3E and a mouse 3F as an input device, and stereoscopic goggles 3G connected to the computer main unit 3A.

The radiologist workstation 3 is included in the mammography displaying system of the present embodiment. Here, various kinds of processes are performed based on a predetermined software program, including requesting the image information management server 5 to view images, displaying images received from the image information management server 5, automatically detecting/highlighting a lesion portion within the images, supporting generation of the image interpretation report, requesting the image interpretation report server 7 to register or view the image interpretation report, displaying the image interpretation report received from the image interpretation report server 7, and the like.

The diagnostician workstation 4 is a computer used by a diagnostician to inspect the images, view the image interpretation report, view/input an electronic medical record card, and the like. Similar to the radiologist workstation 3, the diagnostician workstation 4 includes a computer main unit 4A, two displays (display unit) 4B and 4C, and the like.

The image information management server 5 is a general-purpose high processing performance computer combined with a software program that provides a function of the database management system (DBMS). The image information management server 5 has a large capacity storage included in the image information database 6.

In the image information database 6, image data indicating subject images and additional information are registered. The additional information includes, for example, image identifications for identifying individual images, patient identifications for identifying the subject, patient information, imaging portions, imaging conditions, and the like.

As the image information management server 5 receives a registration request of the image information from the image-capturing control computer system 2, the image information management server 5 aligns the image information in a database format and registers them in the image information database 6. As a view request is received from the workstation 3 or 4 via networks 9, such an image information management server 5 searches image information registered in the image information database 6, and transmits the retrieved image information to the requesting workstation 3 or 4.

As a user such as a radiologist or a diagnostician performs manipulation to issue a request for viewing reading/inspection target images, the radiologist workstation 3 or the diagnostician workstation 4 transmits the request to the image information management server 5 and obtains necessary image information. The image information is displayed on a monitor screen, and automatic lesion discrimination and the like are carried out in response to a user's request.

The radiologist workstation 3 displays a report generation screen for supporting generation of the image interpretation report, for example, on the display 3B. As texts representing opinion or the like are input by the radiologist through a keyboard 3D or a mouse 3F, the radiologist workstation 3 generates the image interpretation report on which the input information and the reading target images are recorded. The radiologist workstation 3 transmits the generated image interpretation report to the image interpretation report server 7 via networks 9, and issues a request to register the corresponding report on the image interpretation report database 8. The image interpretation report will be described in detail below.

As the image interpretation report server 7 receives the registration request of the image interpretation report from the radiologist workstation 3, the image interpretation report is aligned in a database format, and registered on the image interpretation report database 8. On the image interpretation report database 8, for example, image identifications for identifying reading target images or representative images, reader identifications for identifying image diagnosticians who carry out the reading, position information on areas of interest, opinion, and opinion confidence are registered.

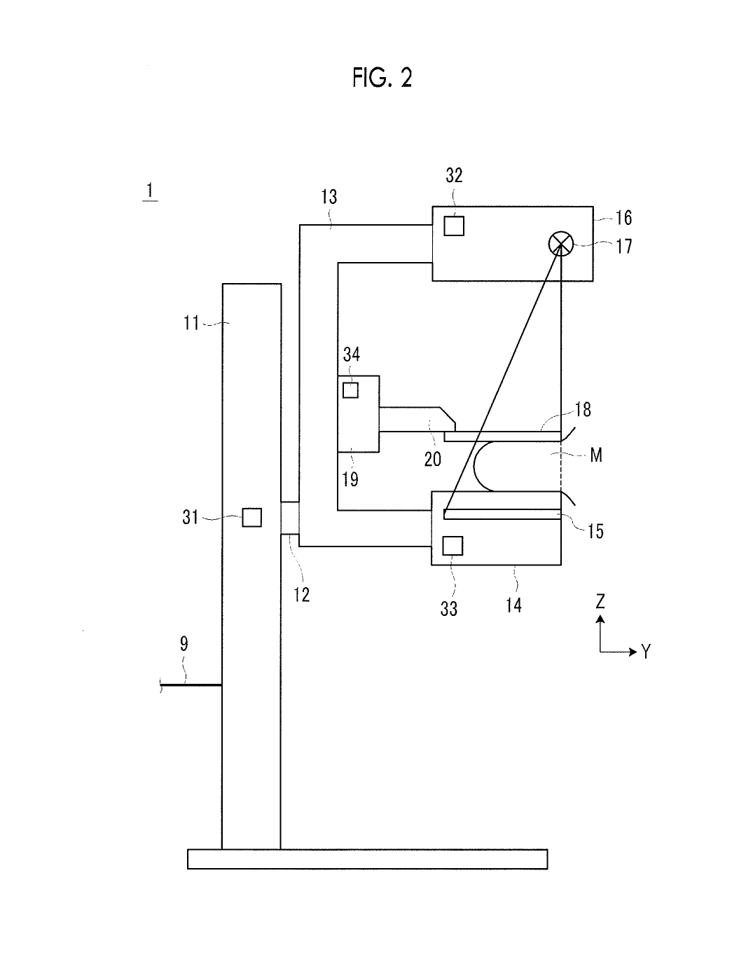

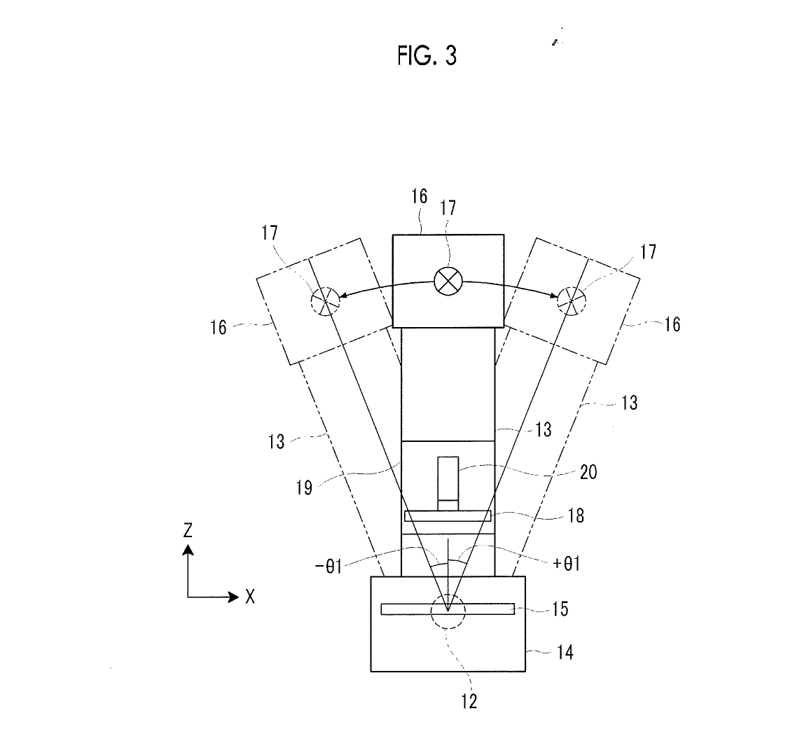

Next, the mammographic imaging unit 1 will be described with reference to FIGS. 2 and 3, which show a side shape and front shape thereof. The mammographic imaging unit 1 is a device capable of capturing, particularly, a plurality of mammographic images included in a stereoscopic image (stereo image), to which the main unit 2A of the computer system 2 is connected via networks 9 as shown in FIG. 1.

Referring to the side shape of FIG. 2, the mammographic imaging unit 1 includes a support post 11, a rotational axis 12 movable upwardly or downwardly (in the Z direction) and rotatable with respect to the support post 11, and an arm 13 connected to the support post 11 by the rotational axis 12. In addition, FIG. 3 illustrates a front shape of the arm 13 as seen from the right side of FIG. 1.

The arm 13 has a C-shape, of which one end is provided with a stand 14, and the other end is provided with a radiation exposure unit 16 to face the stand 14. The rotation and vertical movement of the arm 13 is controlled by the arm controller 31 installed in the support post 11.

The internal side of the stand 14 is provided with a radiographic image detector 15 such as a flat panel detector and a detector controller 33 for controlling reading of the charge signal from the radiographic image detector 15. The internal side of the stand 14 is also provided with a circuit board or the like containing a charge amplifier for converting the charge signal read from the radiographic image detector 15 into a voltage signal, a correlation double-sampling circuit for sampling a voltage signal output from the charge amplifier, an AD converter for converting a voltage signal into a digital signal, and the like, and description thereof will be omitted for simplification purposes.

The stand 14 is configured rotatable with respect to the arm 13. As a result, even when the arm 13 is rotated with respect to the rotational axis 12 relative to support post 11, the stand 14 is maintained in a constant direction relative to the support post 11.

The radiographic image detector 15 is capable of repeatedly writing and reading the radiographic images. A so-called direct-type radiographic image detector may be used, in which radioactive rays are directly received to generate electric charges. A so-called indirect-type radiographic image detector may be used, in which the radioactive rays are converted into visible light, and the visible light is converted into an electric charge signal. In addition, as a method of reading the radioactive image signal, the radioactive image signal is read by turning on/off the thin-film transistor (TFT) switch. Preferably, a so-called TFT-reading type or a so-called optical reading type, in which the radioactive image signal is read by emitting reading light, is employed. However, other types may be employed without limitation.

The radiation irradiation unit 16 is provided with a radiation source 17 and a radiographic source controller 32. The radiographic source controller 32 controls a timing for emitting radioactive rays from the radiation source 17 and a radioactive ray generation condition (such as a tube current, time, and time-integration of the tube current) in the radiation source 17.

The center of the arm 13 is provided with a compression plate 18 is arranged in the upper side of the stand 14 to compress the breast M, a support 20 for supporting the compression plate 18, and a shifting mechanism 19 for shifting the support 20 in the vertical direction (Z direction). The position of the compression plate 18 and the compressing pressure are controlled by the compression plate controller 34.

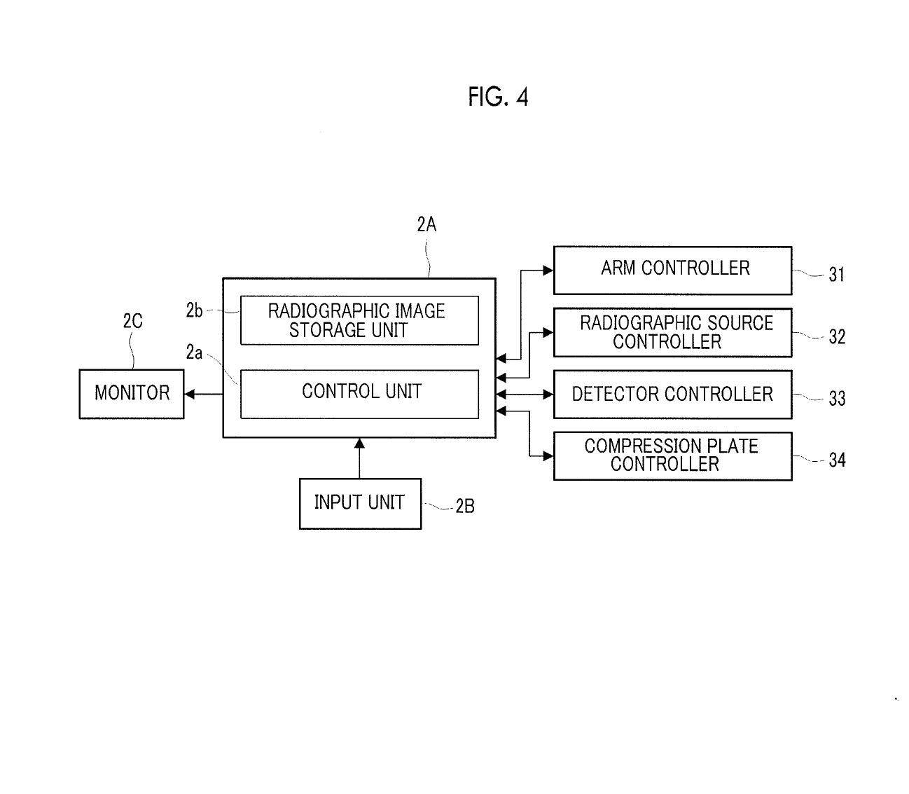

Next, the aforementioned computer system 2 for controlling operations of the mammography apparatus 1 will be described with reference to FIG. 4. The computer system 2 includes a central processing unit (CPU) and a storage device such as a semiconductor memory, a hard disk, and a solid-state device (SSD). Specifically, computer system 2 includes a computer main unit 2A, an input unit 2B such as a keyboard connected thereto, a monitor 2C similarly connected to the computer main unit 2A, and the like.

In the computer main unit 2A, the control unit 2a and the radiographic image storage unit 2b shown in the same drawing are included. The control unit 2a outputs a predetermined control signal to various controllers 31 to 34 described above and controls the entire imaging unit. Details of the control will be described below. The radiographic image storage unit 2b stores a radiographic image signal for each imaging angle obtained by the radiographic image detector 15.

The input unit 2B includes a pointing device such as a keyboard or a mouse and receives user's input such as an imaging condition or input of manipulation instructions. One of the monitors 2C is used to recognize the imaging range of the subject or, in some instances, reproduce/display the stereoscopic image as described below.

Next, an imaging process in the mammography apparatus 1 will be described. First, as shown in FIG. 2, the breast M is arranged on the stand 14, and compressed by the compression plate 18 with a predetermined pressure. At this moment, the arm 13 is set to an initial position facing a direction perpendicular to the stand 14, that is, the position indicated by the solid line in FIG. 3.

Next, using the input unit 2B, various imaging conditions for each user are input, and an input is made for instructing whether the radiographic image for displaying the breast stereoscopic image is captured, or a whether a typical radiographic image is captured. In a case where an instruction is input for capturing the radiographic image for displaying the breast stereoscopic image, the control unit 2a reads a predetermined image capturing angle θ1 (an angle between the irradiation axis and a normal line of a radiographic detection surface) from the internal memory and outputs the information on the imaging angle θ1 to the arm controller 31.

According to the present embodiment, it is assumed that θ1=±2° is stored in advance as information on the imaging angle θ1. However, the present invention is not limited thereto, and the imaging angle θ1 may be set to other angle ranges such as ±2° to ±5°. According to the present embodiment, the arm 13 is rotatably structured with respect to the rotational axis 12, and the rotational axis 12 is arranged to have approximately the same height as that of the radiographic image detector 15. For this reason, as shown in FIG. 3, irradiation axes of the radiation source 17 located in a different rotation position intersect with each other in the vicinity of the radiographic image detector 15. However, the present invention is not limited thereto. The arm 13 may be rotated while the irradiation axes intersect with each other inside the breast M as a target subject.

Next, the arm controller 31 receives the information on the imaging angle θ1 output from the control unit 2a and outputs the control signal for rotating the arm 13 by +θ1=+2° from the initial position based on the information on the imaging angle θ1. In response to the control signal, the arm 13 is rotated by +2°.

Subsequently, the control unit 2a outputs a control signal for irradiating radioactive rays and reading the radiographic image signal to the radiographic source controller 32 and the detector controller 33. In response to the control signal, the radioactive rays are emitted from the radiation source 17, and the radiographic images obtained by imaging the breast from a direction of +2° is detected by the radiographic image detector 15. Then, the radiographic image signal is read from the radiographic image detector 15 by the detector controller 33, and predetermined signal processing is carried out for the radiographic image signal to obtain radiographic image data so that the resulting data are stored in the radiographic image storage unit 2b of the computer main unit 2A.

Next, the aim controller 31 recovers the arm 13 to an initial position, and then, outputs a control signal for rotating the arm 13 from the initial position by −θ1=−2°. As a result, the arm is rotated by −2° from the initial position.

Subsequently, the control unit 2a outputs a control signal for irradiating radioactive rays and reading the radiographic image signal to the radiographic source controller 32 and the detector controller 33. In response to the control signal, the radioactive rays are emitted from the radiation source 17, and the radiographic image obtained by imaging the breast from a direction of −2° is detected by the radiographic image detector 15. Then, the radiographic image signal from the radiographic image detector 15 is read by the detector controller 33, and predetermined signal processing is carried out for the radiographic image signal so as to obtain the radiographic image data. The radiographic image data are stored in the radiographic image storage unit 2b of the computer main unit 2A.

As a result, the data on two images temporarily stored in the radiographic image storage unit 2b carry radiographic images having parallax. In the image information database 6 shown in FIG. 1, the data on one of two images as the right-eye image data, and the data on the other image as the left-eye image data are stored along with additional information. The image data regarding a pair of the radiographic images are provided to the radiologist workstation 3 or the diagnostician workstation 4 of FIG. 1 to display a stereoscopic image (stereo image) of an subject.

The aforementioned imaging process is performed for each of a pair of left and right breasts of the same examinee. Therefore, a pair of the image data pieces (for the left and right breasts) representing two radiographic images are generated, and all of them are stored in the image information database 6.

Next, a process of displaying the stereoscopic image in the radiologist workstation 3 will be described. As a request for viewing a desired radiographic image is transmitted to the image information management server 5 from the radiologist workstation 3 via networks 9, the image information management server 5 searches the image information registered in the image information database 6, and the retrieved image information is transmitted to the requesting radiologist workstation 3. In a case where the viewing request is related to radiographic image data on left and right breasts of a single person, a pair of the image data regarding a pair of the radiographic images (image data on one of the breasts) and the image data regarding a pair of the radiographic images (image data on the other breast) as described above are transmitted to the radiologist workstation 3.

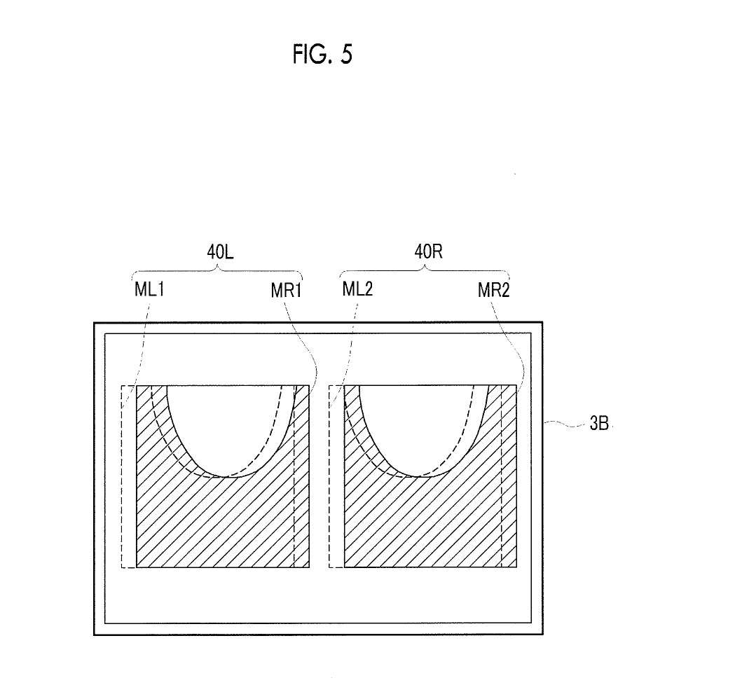

The computer main unit 3A of the radiologist workstation 3 temporarily stores the transmitted radiographic image data in an internal memory, and displays side by side the mammographic images 40L and 40R indicated by the data on the display 3B as shown in FIG. 5. Here, the mammographic image 40L regarding one breast includes a right-eye image MR1 and a left-eye image ML1 having parallax, and the mammographic image 40R regarding the other breast also includes a right-eye image MR2 and a left-eye image ML2 having parallax. Such right-eye images MR1 and MR2 and the left-eye images ML1 and ML2 are displayed in an alternately switching manner, for example, with a cycle of about (1/several tens) seconds in the order of a right-eye image, a left-eye image, a right-eye image, a left-eye image, . . . , and so forth.

Meanwhile, the left-eye and right-eye portions of the stereoscopic goggles 3G connected to the radiologist workstation 3 are provided with a shutter such as a liquid crystal shutter independently opened/closed. Opened/closed states of the shutter is controlled by the computer main unit 3A of the radiologist workstation 3 in synchronization with switched display of the right-eye images MR1 and MR2 and the left-eye images ML1 and ML2, such that the right-eye portion is opened and the left-eye portion is closed while the right-eye images MR1 and MR2 are displayed, and in turn, the left-eye portion is opened and the right-eye portion is closed while the left-eye images ML1 and ML2 are displayed.

In this regard, as the radiologist or the like wears the stereoscopic goggles 3G and observes the display 3B, only the right-eye images MR1 and MR2 are viewed through the right eye, and only the left-eye images ML1 and ML2 are viewed through the left eye. Therefore, the mammographic images 40L and 40R are displayed as a stereoscopic image having a depth. In addition, since the mammographic image 40L representing one breast and the mammographic image 40R representing the other breast are displayed side by side, the radiologist or the like can read a pair of mammographic images 40L and 40R in a comparative manner.

According to the present embodiment, two radiographic images for a stereoscopic image are captured by changing the irradiation direction on the X-Z plane of FIG. 3. However, a plurality of radiographic images may be captured by changing the irradiation direction to other directions. That is, for example, a plurality of radiographic images may be captured by changing the irradiation direction on the Y-Z plane of FIG. 2, and a stereoscopic image may be displayed based on a plurality of the radiographic images obtained in this manner.

Here, in the mammographic images 40L and 40R displayed as described above, it is likely that parallax between the right-eye image MR1 and the left-eye image ML1 is different from parallax between the right-eye image MR2 and the left-eye image ML2. Such a situation is generated primarily when the breast compressing pressure of the compression plate 18 differs in a case for capturing the mammographic image 40L and a case for capturing the mammographic image 40R, or when the left and right breasts differ in size.

In this manner, if parallax is different between two images as described above, the sense of depth of the mammographic image 40L is different from the sense of depth of the mammographic image 40R. As a result, it may be difficult to read both mammographic images 40L and 40R in a comparative manner. In addition, when a pair of stereoscopic images are displayed on the same display screen as in the present embodiment, it may be difficult to achieve a stereoscopic view.

Hereinafter, a configuration for addressing such a problem will be described. The control unit 2a shown in FIG. 4 receives a signal from the compression plate controller 34 when the mammographic image is captured using the mammography apparatus 1 and detects a vertical position of the compression plate 18. Here, the vertical position refers to a position of the compression plate along the vertical direction when a direction in which the compression plate descends refers to a lower direction, and a direction in which the compression plate ascends refers to an upper direction. The vertical position of the compression plate 18 indirectly indicates a compressed thickness of the breast M. In addition, the control unit 2a inputs a control signal to the arm controller 31 such that the imaging angle θ1 shown in FIG. 3 increases as the detected vertical position of the compression plate 18 is lower (that is, as the compressed thickness of the breast M is smaller). The arm controller 31 controls the rotation position of the arm 13 based on the control signal such that the imaging angle θ1 increases as the compressed thickness of the breast M is smaller. As a result, a pair of radiographic images for displaying the stereoscopic image is captured such that parallax increases as the compressed thickness of the breast M is small.

Originally, the sense of depth of the stereoscopic image attenuates as the compressed thickness of the breast M during the imaging decreases. In this case, it is possible to increase the sense of depth of the stereoscopic image displayed from a pair of the images if a pair of images is captured by increasing parallax as described above. In this regard, a pair of left and right mammographic images (stereoscopic images) 40L and 40R can be displayed with a matched sense of depth.

As is apparent from the foregoing, according to the present embodiment, the compression plate controller 34 constitutes compressed thickness detection unit of the present invention, and the control unit 2a and the arm controller 31 constitute imaging control unit of the present invention.

In addition, a relation between the compressed thickness and the imaging angle θ1 suitable for that can be obtained in an empirical or experimental manner. Therefore, if such a relation is stored in a memory, for example, in a numerical format, a function format, or a lookup table format, a suitable imaging angle θ1 can be conveniently established by referencing the lookup table from the detected compressed thickness when the radiographic image is captured.

In addition, as the imaging angle θ1 increases, depth resolution of the stereoscopic image increases. On the contrary, it is difficult to achieve a stereoscopic view. In this regard, in a case where the parallax is controlled by increasing the imaging angle θ1, it is preferable that the imaging angle θ1 be suppressed so as not to hinder a stereoscopic view.

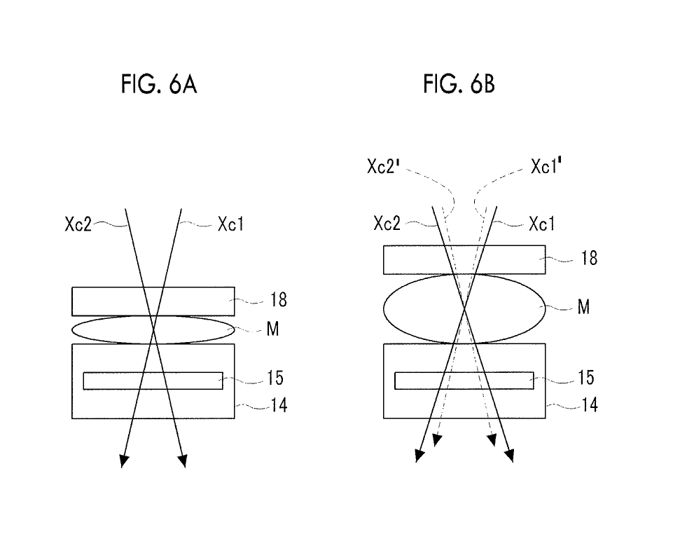

As shown in FIGS. 6A and 6B, the imaging angle θ1 may be changed by allowing the irradiation axes Xc1 and Xc2, which change in every imaging try, to intersect with each other inside the breast M as a target subject. Even in this case, as shown in FIG. 6A, the imaging may be performed by increasing the imaging angle θ1 (the irradiation axes Xc1 and Xc2 indicated by the solid line) when the compressed thickness of the breast M is relatively small. As shown in FIG. 6B, the imaging may be performed by reducing the imaging angle θ1 (the irradiation axes Xc1′ and Xc2′ indicated by the dotted line) when the compressed thickness of the breast M is relatively large.

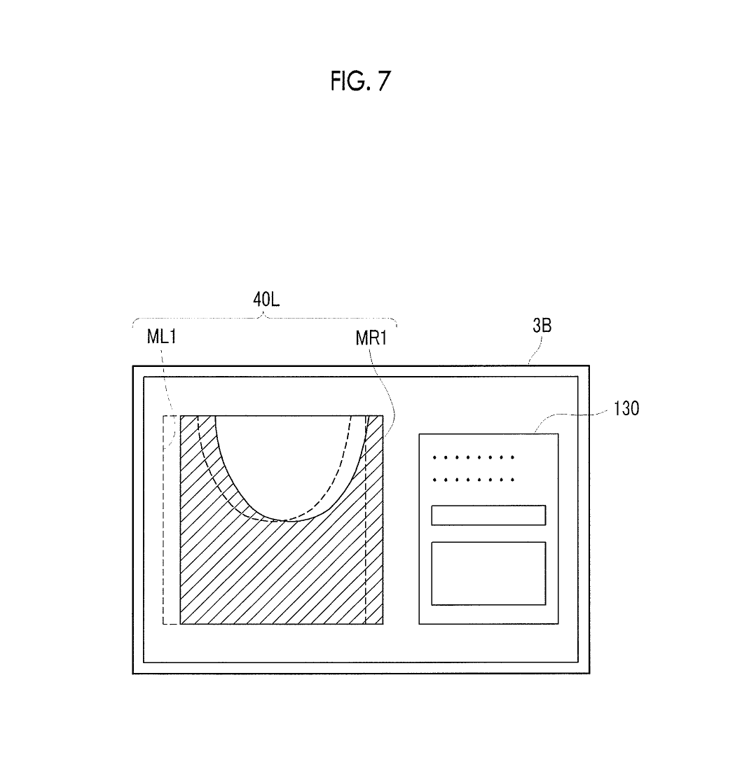

Although the mammographic images 40L and 40R are displayed side by side on the same display screen in the aforementioned embodiment, they may be individually displayed on different display screens (that is, screens may be displayed with a time interval on the same display unit, or screens may be displayed on different display unit). FIG. 7 illustrates one of the display screens, where a mammographic image 40L including the right-eye image MR1 and the left-eye image ML1 is displayed. Similarly, in this case, it is possible to read the mammographic images 40L and 40R displayed with a time interval in a comparatively readable manner. In addition, the present invention may be applicable to this case, and the same effect can be obtained as described above. The reference numeral 130 of FIG. 7 denotes an image interpretation report display area opened as a window.

Although a single stereoscopic image is displayed with two images in the aforementioned embodiment, a single stereoscopic image may be displayed with three or more images. Even in this case, the present invention may be applicable, and the same effect can be obtained as described above.

The method of displaying the stereoscopic image is not limited to the aforementioned method in which stereoscopic goggles are used. A polarization filter may be applicable.

What is claimed is:

1. A mammography displaying method using a mammography displaying system that captures a plurality of images having parallax for each of a pair of left and right breasts while a pair of the left and right breasts are compressed respectively, and displays a stereoscopic image having a plurality of images regarding one of the breasts and a stereoscopic image having a plurality of images regarding the other breast on display unit in a comparatively readable manner, the method comprising:
detecting compressed thicknesses for each of the breasts when images are captured; and
capturing a plurality of images by enlarging parallax as the detected compressed thickness is small.

2. A mammography displaying system that captures a plurality of images having parallax for each of a pair of left and right breasts while a pair of the left and right breasts are compressed respectively, and displays a stereoscopic image having the plurality of images regarding one of the breasts and a stereoscopic image having the plurality of images regarding the other breast on display unit in a comparatively readable manner, the system comprising:
compressed thickness detection unit for detecting compressed thicknesses for each of the breasts when images are captured; and
imaging control unit for capturing the plurality of images by enlarging parallax as the detected compressed thickness is small.

3. The mammography displaying system according to claim 2, wherein the compressed thickness detection unit detects the compressed thickness based on a position of the compression plate that compresses the breast when images are captured.

4. The mammography displaying system according to claim 2, wherein the imaging control unit controls parallax by controlling the imaging angle when the plurality of images are captured.

5. The mammography displaying system according to claim 3, wherein the imaging control unit controls parallax by controlling the imaging angle when the plurality of images are captured.
